(19) United States
(12) Patent Application Publication
(10) Pub. No.: US 2020/0278675 A1
(43) Pub. Date: Sep. 3, 2020

(54) REMOTELY CONTROLLED AIRBORNE VEHICLE PROVIDING FIELD SENSOR COMMUNICATION AND SITE IMAGING DURING FACTORY FAILURE CONDITIONS

(71) Applicant: Honeywell International Inc., Morris Plains, NJ (US)

(72) Inventors: Anitha Balathandapani, Bangalore (IN); Uday Krishna P, Visakhapatnam (IN); Rahul Ramesh Bhaskarwar, Hyderabad (IN)

(21) Appl. No.: 16/646,825

(22) PCT Filed: Sep. 15, 2017
(86) PCT No.: PCT/US2017/051699

§ 371 Date: Mar. 12, 2020

(51) Int. Cl. G05D 1/00; G05D 1/10; G05D 1/12; B64C 39/02; G02B 27/01

(52) U.S. Cl. CPC G05D 1/0038; G05D 1/104; G05D 1/0094; B64C 2201/146; G05D 1/0022; B64C 39/024; G02B 27/0172; G05D 1/12

(57) ABSTRACT

Apparatus and associated methods relate to a remotely controlled airborne vehicle (RCAV) configured to establish a temporary wireless communication link between a control room server and an industrial controller during a factory malfunction, the link for transmission of control commands and reception of sensor data, the RCAVs including a camera configured to transmit live video, the control room server configured to display the live video augmented with the sensor data. In an illustrative example, the industrial controller may be electrically coupled to sensors and actuators that may be part of a factory automation system. Various embodiments may include one or more RCAVs feeding a video processor within the server to produce 3-dimensional (3D) images which may be transmitted, for example, for display on a 3D projection headset. Various embodiments may advantageously provide emergency network connection between control rooms and process control equipment to mitigate hazards within a factory.

### TECHNICAL FIELD

Various embodiments relate generally to industrial safety using remotely operated vehicles.

### BACKGROUND

Factory automation is used within many industries. Automation may provide a financial benefit since automation of factory processes may be faster than manual processes. In addition, some factory processes involve dangerous temperatures, pressures, sound, or moving parts, and therefore automation may substantially remove humans from such hazardous environments.

Factory automation often employs computer processing in the form of programmable logic controllers (PLCs). PLCs may receive various analog or digital inputs. For example, a PLC may monitor a proximity detector which may indicate an item on a factory conveyor belt. In some examples, various sensors may be coupled to a PLC input. For example, a PLC may monitor the temperature of the process. Further, PLCs may generate various analog or digital outputs. For example, a PLC may open a valve, or start a pump. Accordingly, PLCs may be employed to control an entire process. In an illustrative example, a PLC with a coupled sensor may determine that a material has reached a certain temperature, and in response, the PLC may drive a linear actuator to remove the material from the heat source.

PLCs may be monitored or controlled remotely. This remote monitoring and control may be employed by wired or wireless communication. As such, some factories may employ a central control room, where control room operators may monitor various processes within a factory.

### SUMMARY

Apparatus and associated methods relate to a remotely controlled airborne vehicle (RCAV) configured to establish a temporary wireless communication link between a control room server and an industrial controller during a factory malfunction, the link for transmission of control commands and reception of sensor data, the RCAVs including a camera configured to transmit live video, the control room server configured to display the live video augmented with the sensor data. In an illustrative example, the industrial controller may be electrically coupled to sensors and actuators that may be part of a factory automation system. Various embodiments may include one or more RCAVs feeding a video processor within the server to produce 3-dimensional (3D) images which may be transmitted, for example, for display on a 3D projection headset. Various embodiments may, advantageously provide emergency network connection between control rooms and process control equipment to mitigate hazards within a factory.

Apparatus and associated methods also relate to use of two or more camera-equipped remote controlled airborne vehicles to produce 3D real-time video.

Various embodiments may achieve one or more advantages. For example, some embodiments may provide a method of automatic data collection and display without manual intervention, and in some instances without stopping the operations. Emergency interfaces between industrial field controllers and operators may be provided when industrial fixed communication channels fail. Live video feeds augmented with factory sensor data may be helpful in understanding various site malfunctions for effective and safe mitigation. Factory operators may be provided with field data and field video to more rapidly, safely, and flexibly determine the degree of human hazard present, keeping field personnel out of harm's way. Accordingly, control room operators may be provided real-time, reliable, and critical parametric and video information during an emergency. Such information may provide significant cost savings in terms of manual labor for intensive test mechanisms. In some examples, operators may be provided with automated reports of collected video and/or data. Compliance to various health, and environmental safety guidelines may be advantageously met.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary remote controlled airborne vehicle providing field sensor communication and site imaging during an emergency.

FIG. 2 depicts an exemplary pair of remote controlled airborne vehicles providing a stereo view of an industrial worksite to a user wearing 3D projection glasses.

FIG. 3 depicts an exemplary process within a factory to remediate a fault notification displayed in a control room.

FIG. 4 depicts an exemplary remote controlled air vehicle deployment system.

Like reference symbols in the various drawings indicate like elements.

### DETAILED DESCRIPTION OF ILLUSTRATIVE EMBODIMENTS

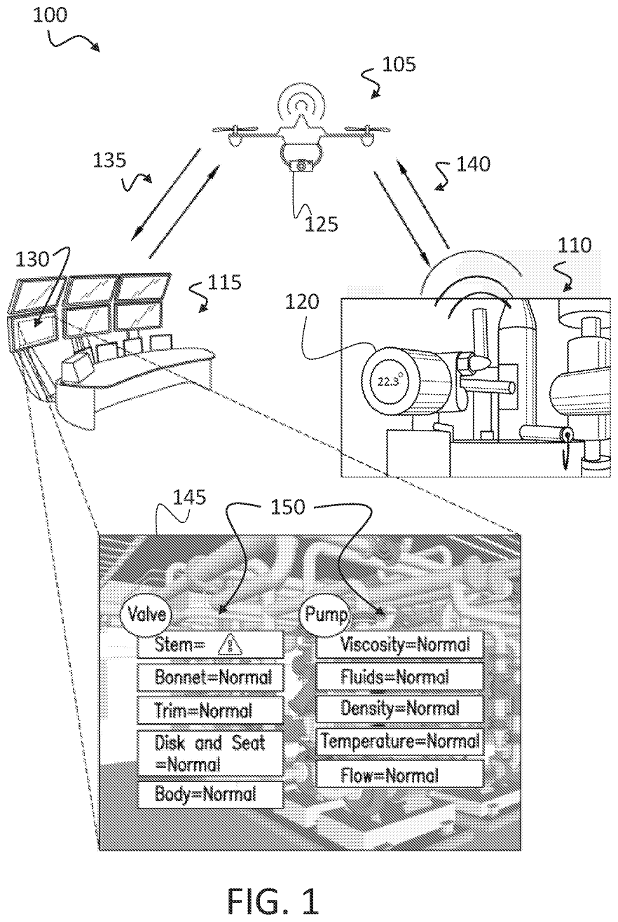

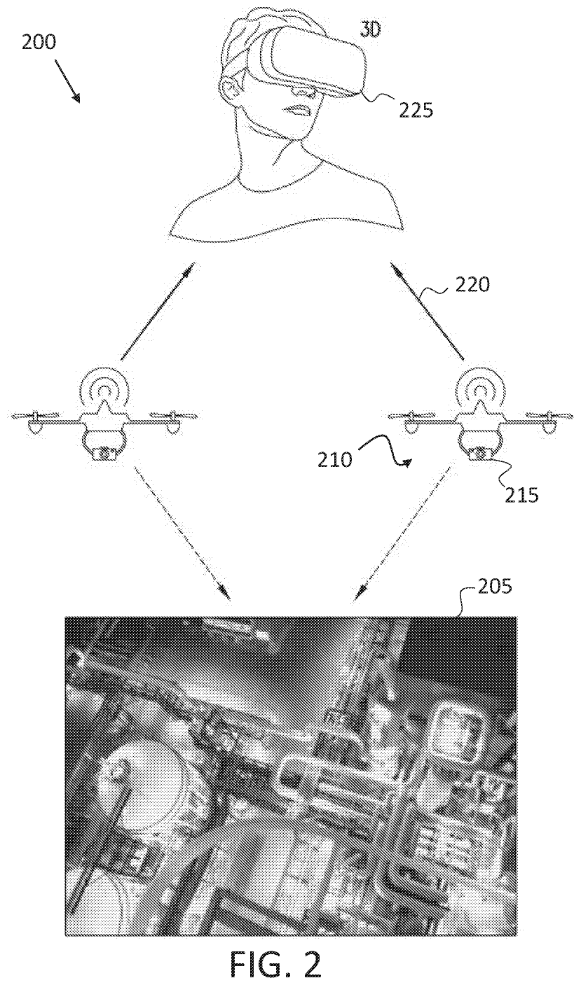

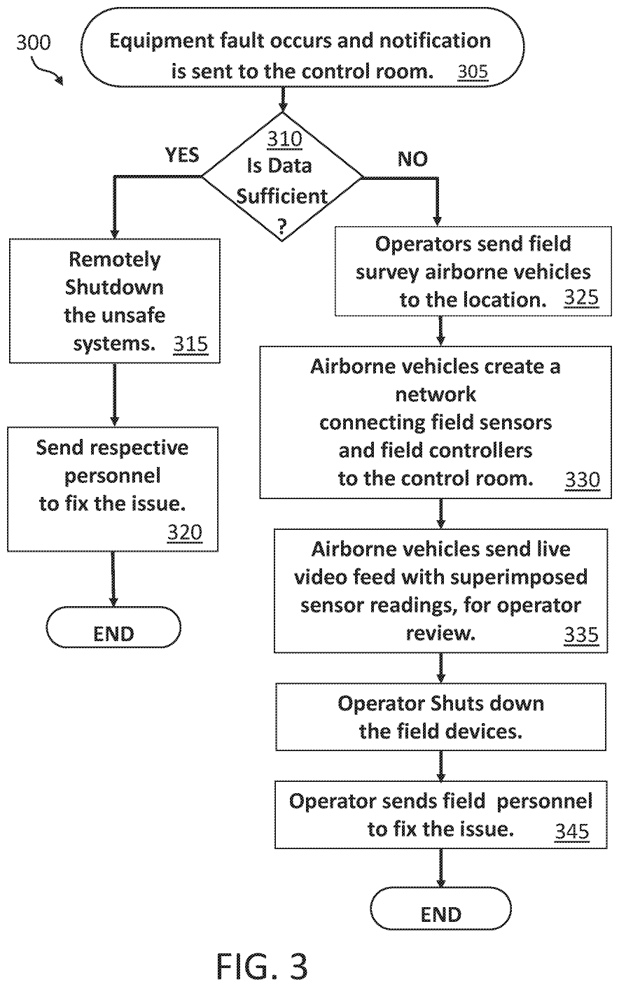

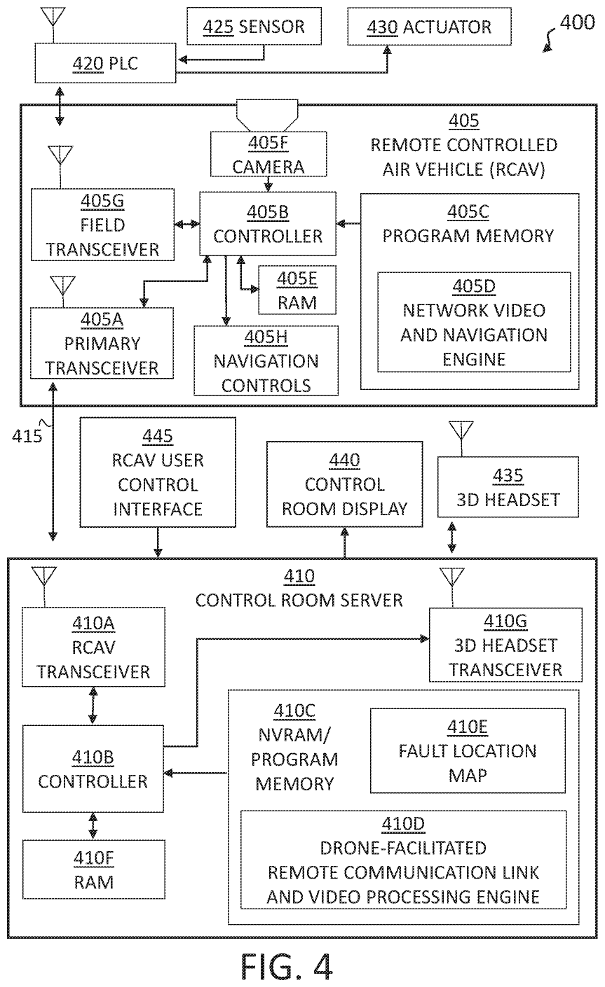

To aid understanding, this document is organized as follows. First, various use cases are briefly introduced with reference to FIGS. 1 and 2. Second, with reference to FIG. 3, the discussion turns to an exemplary factory procedure following a fault notification. Finally, with reference to FIG. 4, a block diagram of an exemplary system is presented to provide context to the descriptions.

FIG. 1 depicts an exemplary remote controlled airborne vehicle providing field sensor communication and site imaging during an emergency. An emergency situation 100 includes a remote controlled airborne vehicle 105. The remote controlled airborne vehicle 105 has been dispatched to an origination location 110 of a fault notification. The origination location 110 of the fault notification is displayed in a control room 115. The fault notification is signaled by a field-installed programmable logic controller (PLC) 120. In some examples, the PLC 120 may be referred to as the wireless connected device. When the remote controlled airborne vehicle 105 reaches the origination location 110, a camera 125 coupled to the airborne vehicle 105 is activated. The airborne vehicle 105 receives a video stream from the camera 125. The airborne vehicle 105 transmits the video stream to the control room 115. The control room 115 receives the video stream, displaying the image from the camera 125 onto a monitor 130. The airborne vehicle 105 also provides an emergency wireless communication link between a control room communication link 135 and a PLC communication link 140. The monitor 130 presents a display image 145. The display image 145 includes the image from the camera 125 superimposed with real time PLC sensor data 150. In some examples, the PLC sensor data 150 may be referred to as the parametric information. The PLC sensor data 150 superimposed with the image from the camera 125 may advantageously allow operators to monitor several aspects, and/or from several vantage points at once. Further, the superimposed images may provide the user with automatic and up-to-date notifications of current malfunctions through the real-time video feed combined with the parametric feed.

The control room 115 manned with various human operators is now provided with communications to the field installed PLC 120 and with visual contact. The control room operators may advantageously view the PLC sensor data 150 from the PLC 120 and may visually survey the origination location 110. Armed with these two aspects of the situation, the operators may advantageously control various actuators connected to the PLC 120 of the emergency wireless communication link. In this way, the operators may place potentially dangerous factory equipment into a safe state. Operators may then safely dispatch factory personnel to the origination location 110 for further repairs or remediation. The remote controlled airborne vehicle providing field sensor communication and site imaging may advantageously allow operators to understand more about various fault notifications, enable the operators to place dangerous equipment into a safe state, and safely dispatch personnel to the location.

FIG. 2 depicts an exemplary pair of remote controlled airborne vehicles providing a stereo view of an industrial worksite to a user wearing 3D projection glasses. A surveillance scenario 200 includes an industrial worksite 205. In some examples, the industrial worksite 205 may be referred to as the target site. The industrial worksite 205 may be in an area that is hazardous to humans. The hazardous conditions may be due to a fault notification originating from the area. In some examples, the hazardous conditions may be systemic due to the industrial processing present. In the depicted example, two aerial vehicles 210 are sent to the industrial worksite 205. The aerial vehicles 210 each contain a camera 215. The cameras 215 are aimed at the industrial worksite 205 at two different locations. The cameras 215 produce two camera images 220 terminating at a user's 3D projection glasses 225. In some examples, the 3D projection glasses 225 may be referred to as the user display device. In some embodiments, the transmitted camera images 220 may be transmitted to a central server where they may be further processed before they are transmitted to the user's 3D projection glasses 225. In some examples, this stereo view of the industrial worksite 205 may be provided to operators in addition to the functions described in FIG. 1.

In some embodiments, multiple aerial vehicles 210 may be sent to the industrial worksite 205 and may interact together to send live, parametric augmented, 3D data to the operator. The operator may view the 3D data via 3D projection glasses 225, analyze the situation accurately, and take appropriate action.

The aerial vehicles 210 may be employed to send live 3D video of various factory machinery. In some examples, the aerial vehicles 210 may be deployed in various positions around factory machinery. For example, the aerial vehicles 210 may be deployed at the top of a factory machine, providing operators with a top view which may otherwise be inaccessible, hazardous or labor-intensive. In some examples, the aerial vehicles 210 may be deployed at one or more sites within the factory machine providing flexibility to the operator to view whatever portion of the factory machine that needs visual inspection or monitoring. In some embodiments, the aerial vehicles 210 may capture various incidents. For example, some fault notifications may be indicators of incipient failures. The aerial vehicles 210 may be deployed to the site of the fault notification, recording video feeds. The recordings may be analyzed at a later time to determine root cause, or for example, improve worker safety.

FIG. 3 depicts an exemplary process within a factory to remediate a fault notification in a control room. A factory fault remediation process 300 includes a block 305 where an equipment fault occurs and notification is sent to the control room. At decision block 310, one of two paths may be taken dependent upon the adequacy of data being received by factory PLCs.

If the PLC's are sending adequate data, then at block 315 the operators remotely shutdown the unsafe systems. Then, at block 320 the operators send appropriate personnel to fix the issue.

If the PLCs are not sending adequate data, then at block 325 the operators send field survey airborne vehicles to the location. Next, at block 330 the airborne vehicles create a temporary wireless network. The network temporarily connects various field sensors and field controllers to the control room. At block 335, the airborne vehicles send live, multi-perspective, video augmented with superimposed sensor readings for the operator to review. The operator then shuts down the field devices as appropriate, at block 340. Next the operator dispatches various field personnel to remediate the issue, at block 345.

FIG. 4 depicts an exemplary remote controlled air vehicle deployment system. A remote controlled air vehicle deployment system 400 includes a remote controlled air vehicle (RCAV) 405. The remote controlled air vehicle deployment system 400 also includes a control room server 410. The RCAV 405 is in operable wireless communication with the control room server 410 via a first communication link 415. The first communication link 415 is operably coupled to a primary transceiver 405A.

The primary transceiver 405A is connected to a controller 405B. The controller 405B executes pre-programmed commands from a program memory 405C. The program memory 405C includes a network video and a navigation engine 405D. The network video and the navigation engine 405D provides the execution code to the controller 405B, providing the RCAV 405 with its functionality. The controller 405B is operably coupled to a random-access memory (RAM) 405E. The RAM 405E facilitates the controller's 405B basic functionality. The controller 405B is operably coupled to a camera 405F.

The camera 405E is operable to provide image data to the controller 405B. The controller 405B is operably coupled to a field transceiver 405G. The field transceiver 405G provides a wireless communication link to a variety of field programmable logic controllers (PLCs) 420. In some examples, multiple PLCs 420 may be referred to as the wireless connected devices. The controller 405B is operably connected to an RCAV navigational control 405H. The RCAV navigational controls 40514 may include various servos and motor drivers operable to control the motion of the RCAV 405.

The PLC 420 receives signals from various sensors 425. In some examples, the sensors 425 may be referred to as field sensors. The sensors 425 may provide parametric signals representing, for example, proximity, pressure and temperature within a factory setting. Further, the PLC 420 sends signals to various actuators 430. The actuators 430 may provide control to various equipment, for example, opening/closing valves, engaging/disengaging gears, starting/stopping motors and gating audible and/or visual annunciators.

The control room server 410 includes an RCAV transceiver 410A. In some examples, the RCAV transceiver 410A may be referred to as the control transceiver. The RCAV transceiver 410A is operably connected to a controller 410B. The controller 410B executes pre-programmed commands from a program memory 410C. The program memory 410C includes a drone-facilitated remote communication link and a video processing engine 410D. The drone-facilitated remote communication link and the video processing engine 410D provide the execution code to the controller 410B, providing the control room server 410 with its functionality.

The program memory 410C also includes a fault location map 410E. In some embodiments, the fault location map 410E may be preprogrammed with the locations of various potential faults and may provide the controller 410B with the navigational instructions to command an RCAV to navigate to the location of the fault. The controller 410B is operably coupled to a random-access memory (RAM) 410F. The RAM 410F facilitates the controller's 410B basic functionality. The controller 410B is operably connected to a 3D headset transceiver 410G. The 3D headset transceiver 410G is operable to send video data to a VR headset 435.

The control room server 410 is operably coupled to a control room display 440. The remote controlled air vehicle deployment system 400 may display a video feed from the camera 405F mounted on the RCAV 405. In some examples, various sensor data from the sensors 425 wirelessly transmitted by the PLC 420 may be superimposed onto the video feed from the camera 405F and may be displayed on the control room display 440. In some examples, the video feed from the camera 405E and the sensor data from the sensors 425 may be superimposed on the display within the 3D headset 435. Finally, the control room server 410 receives control inputs from an RCAV user control interface 445. In various examples, the RCAV user control interface 445 may allow an operator to manually control the flight of an RCAV, by employment of various control knobs and joysticks integrated into the RCAV user control interface 445.

In an illustrative example, an industrial worksite may experience an acid leak from an installed pipeline. Safety protocol may dictate various control valves be turned off before addressing the leak manually. However, if communications between the PLC 420 controlling the control valve actuators 430 and the control room is lost, the RCAVs 405 may be deployed to provide an emergency communication interface between the control room server 410 and the PLC 420 controlling the control valve actuators 430. In some examples, the RCAVs 405 may create the emergency communication interface or network using various wireless network protocols (e.g., Wi-Fi, ZigBee, Wireless HART, ISA-100.11a, BlueTooth). The networking aspects of some embodiments may be compatible with a building management system (BMS) control system. Further, the networking aspects of some embodiments may be compatible with a supervisory control and data acquisition (SCADA) control system. The emergency communication interface may allow operators to manipulate the control valves according to safety protocols.

Although various embodiments have been described with reference to the figures, other embodiments are possible. For example, various factory default notifications, may indicate that problematic conditions could exist in multiple locations. Accordingly, the remote controlled air vehicle deployment system may deploy three or more air vehicles, displaying video feeds from each on a single monitor, or on multiple monitors.

In some embodiments, the aerial vehicles (drones) may be manually controlled by an operator. In an illustrative example, an operator receives a fault notification from the manufacturing floor. The operator may manually lookup the location of the fault notification index number to arrive at a manufacturing floor location. The location may include an elevation. Further, the particular fault may reference two or more locations. The operator may employ various controls on the RCAV user control interface (FIG. 4, item 445) to control one or more drones. In some embodiments, a video monitor within the control room may visually highlight the fault location. The video monitor may also visually highlight the location of one or more drones. The operator may also have control over various camera adjustments. For example, the operator may adjust focus, panning, tilting, and zooming. In some implementations, the airborne vehicles may be equipped with advanced sensors, Wi-Fi and 3D video analytics.

In some embodiments, the drones may be automatically controlled by the control room server. In an illustrative example, a fault notification is received by the control room and highlighted on one of the monitors. At the same time, one or more drones are dispatched to the fault location, the location automatically determined by the server by employment of the fault location map (FIG. 4, item 410E). The fault location map contains an index of all possible faults with corresponding locations on a manufacturing floor. The system may automatically determine the number of drones required to visually cover the fault location. Further, system installers may choose the number of drones they wish to implement within the system. The fault location map may provide a list of locations in a prioritized fashion. Accordingly, various installation sites using a limited number of drones may be provided the highest priority video feeds as dictated by the fault location map prioritized list. Soon after the fault notification, the drones are in place, their cameras focused on the locations defined in the fault location map, and video recording has commenced. In addition, the drones have automatically made wireless communication with the wireless controllers at the location of the fault. The wireless communication is actively bridged from the wireless controllers on the factory floor to the control room. The sensor data collected from the wireless controllers is displayed simultaneously with the video images from each drone.

In various examples, touchscreen technology may be employed. The control room server may determine what virtual buttons are appropriate for the situation. As such, the system may be flexible to address a variety of faults.

In some examples, automated drone deployment may advantageously capture video soon after the failure was detected. The response time of this automated deployment may be faster than a human could respond. In situations where there is a prolonged need for drone facilitated video or drone facilitated communications, the system may employ backup drones. Accordingly, as the deployed drones run out of battery power, a backup drone may arrive at the fault site to relieve the initial drone. The initial drone may be automatically navigated to a charging station. In some embodiments, the charging station may employ inductive charging. In this way, drones may take turns at the fault site and at the charger.

In some implementations, the fault location map may contain various camera positions. Implementation of the camera positions may advantageously focus the video feed at the proper location. The camera sighting positions may include, for example, direction, elevation, and magnification. Once the drone is in place, various embodiments may allow the control room operator to make manual adjustments.

In various examples, the fault may be directed toward a length, for example, the failure may be along a conveyor, a length of duct work, or along a chemical pipeline. In such examples, the air vehicle may be automatically directed along a pre-programmed trajectory profile. This trajectory may be programmed within the fault location map. In an illustrative example, in response to a fault location along a length of pipeline, the system may dispatch a single air vehicle to one end of the pipeline. The system may then present the operator with a virtual slider on a touchscreen. The operator may employ the slider to move the drone from one end of the pipeline to the other.

In some embodiments, a method to provide an immense amount of data back to the industrial Big Data servers may be employed (e.g., photographs, videos, thermal and environmental noise monitoring, 3D mapping). The Big Data algorithms may be employed to reveal various patterns, trends, and associations. Although Big Data may be used extensively to model or to explain human behavior, some aspects of Big Data analytics processing the data collected in various embodiments may be employed to improve safety or up-time. In various embodiments, the drone(s) may be extended to map, monitor, and serve up relevant digital information. Such digital information may positively impact productivity and safety in the workplace.

Some embodiments may generate a 3-dimensional (3D) image which may be viewed by an operator wearing 3D projection glasses, in the safe confines of a control room. Further, the 3D image may be projected on a video monitor in front of the operator. The 3D images may be augmented with data from the industrial controllers coupled to factory sensors. This data may be helpful in understanding various site malfunctions so that the site malfunctions may be effectively addressed.

In some implementations, the drones may employ thermal vision cameras. The thermal vision may advantageously allow users to see temperature data in the various images provided by the system. The thermal information may prevent users from interacting with structures that may be at an unsafe temperature. Users may also use displayed thermal characteristics to predict various preventative maintenance. Such maintenance may avoid future failures and/or human injury. In an illustrative example, an electrical cable may short-circuit behind a wall. The additional heat may be detected and shown on-screen for an operator to understand and analyze. Further, safety may be increased as the drones may operate as advanced sensors (e.g., X-ray, thermal imaging). In some examples, advanced drones, when coupled with a robust sensor package and augmented reality, may increase productivity and workplace safety.

In one exemplary aspect, a computer program product (CPP) is tangibly embodied in a computer readable medium and contains instructions that, when executed, cause a processor to perform operations to provide a visual status of a location of interest. The operations include transmitting, via a transmitter, at least one control command signal to an at least one unmanned aerial vehicle (UAV) commanding each of the at least one UAV to travel to a respective predetermined location defined by a predetermined set of coordinates. A further operation includes transmitting, via a transmitter, at least one camera control command signal to the at least one unmanned aerial vehicle (UAV) commanding a camera of the at least one UAV to a predetermined orientation to obtain multiple perspective views of a target site. Another operation includes receiving, via a transceiver of the at least one UAV, real-time video imagery of the target site, wherein the real-time video imagery of the target site originates from the camera of the at least one UAV. Operations further include establishing, via the transceiver of the at least one UAV, a communications link with one or more wireless connected devices in the target site, each of the wireless connected devices being coupled with a respective field sensor that monitors a status of an industrial component. The operations also include fetching, via the transceiver of the at least one UAV, parametric information collected from the respective field sensor, the parameter information being transmitted to the transceiver of the at least one UAV via the communications link. Another operation includes preparing a three-dimensional view of the target site, the three-dimensional view being determined by assembling the real-time video imagery of the target site into a three-dimensional representation. Operations also include associating the parametric information collected from the respective field sensor with the corresponding industrial components found in the three-dimensional view of the target site, and preparing, for presentation to a user, an augmented three-dimensional view of the target site comprising the three-dimensional view of the target site overlaid with a visual representation of the parametric information collected from the respective field sensor.

In some embodiments, the operation of transmitting, via a transmitter, at least one control command signal to an at least one UAV includes commanding the at least one UAV to move in a predetermined motion profile. The predetermined motion profile may include an orbit around the target site.

The operation of transmitting, via a transmitter, at least one control command signal to an at least one UAV may include automatically dispatching the UAV to the respective predetermined location defined by the predetermined set of coordinates. The predetermined location may be determined by a malfunction message originating from the target site. The at least one UAV may include more than one UAV. The operation of transmitting, via a transmitter, at least one control command signal to an at least one UAV may include commanding each of the plurality of UAVs to travel to different predetermined locations.

The operations may further include: sending, for display on a user display device, the augmented three-dimensional view of the target site. The predetermined location may include a predetermined altitude.

The communications link may include a radio frequency link, such as, for example, a Wi-Fi link.

Some aspects of embodiments may be implemented as a computer system. For example, various implementations may include digital and/or analog circuitry, computer hardware, firmware, software, or combinations thereof. Apparatus elements can be implemented in a computer program product tangibly embodied in an information carrier, e.g., in a machine-readable storage device, for execution by a programmable processor and methods can be performed by a programmable processor executing a program of instructions to perform functions of various embodiments by operating on input data and generating an output. Some embodiments may be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example and not limitation, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits). In some embodiments, the processor and the member can be supplemented by, or incorporated in hardware programmable devices, such as FPGAs, for example.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. An exemplary embodiment may be implemented in a computer system that includes a graphical user interface and/or an Internet browser. To provide for interaction with a user, some implementations may be implemented on a computer having a display device, such as an LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from a source to a receiver over a dedicated physical link (e.g., fiber optic link, infrared link, ultrasonic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, FireWire, ATA/IDE, RS-232, RS-422, RS-485, 802.11 a/b/g/n, Wi-Fi, WiFi-Direct, Li-Fi, BlueTooth, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

In various embodiments, a computer system may include non-transitory memory. The memory may be connected to the one or more processors may be configured for encoding data and computer readable instructions, including processor executable program instructions. The data and computer readable instructions may be accessible to the one or more processors. The processor executable program instructions, when executed by the one or more processors, may cause the one or more processors to perform various operations.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices. In some embodiments, the remotely controlled airborne vehicle providing field sensor communication and site imaging may be an IoT based drone solution for collecting data and for display by augmented reality. Further, the solution may include an IoT Edge hardware device with embedded software that may be connected securely to a cloud network via wired or wireless connection.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. A method to provide a visual status of a location of interest, the method comprising:
transmitting at least one control command signal to an at least one unmanned aerial vehicle (UAV) commanding each of the at least one UAV to travel to a respective predetermined location defined by a predetermined set of coordinates;
receiving real-time video imagery of the target site from the camera of the at least one UAV;
establishing, via the transceiver of the at least one UAV, a communications link with one or more wireless connected devices in the target site, each of the wireless connected devices being coupled with a respective field sensor that monitors a status of an industrial component;
fetching, via the transceiver of the at least one UAV, parametric information collected from the respective field sensor, the parametric information being transmitted to the transceiver of the at least one UAV via the communications link;
preparing a view of the target site, the view of the target site being determined by assembling the real-time video imagery of the target site;
associating the parametric information collected from the respective field sensor with the corresponding industrial components found in the view of the target site;
preparing, for presentation to a user, an augmented view of the target site comprising the view of the target site overlaid with a visual representation of the parametric information collected from the respective field sensor; and,
sending, for display on a user display device, the augmented view of the target site.

2. The method of claim 1, wherein the operation of transmitting, via the control transceiver, at least one control command signal to an at least one UAV comprises commanding the at least one UAV to move in a predetermined motion profile.

3. The method of claim 2, wherein the predetermined motion profile comprises an orbit around the target site.

4. The method of claim 1, wherein the operation of transmitting, via the control transceiver, at least one control command signal to an at least one UAV comprises automatically dispatching the at least one UAV to the respective predetermined location defined by the predetermined set of coordinates, wherein the predetermined location is determined by a malfunction message originating from the target site.

5. The method of claim 1, wherein the at least one UAV comprises a plurality of UAVs.

6. The method of claim 5, wherein the operation of transmitting, via the control transceiver, at least one control command signal to an at least one UAV comprises commanding each of the plurality of UAVs to travel to different predetermined locations.

7. The method of claim 1, wherein the predetermined location comprises a predetermined altitude.

8. The method of claim 1, wherein the communications link comprises a radio frequency link.

9. The method of claim 1, wherein the view of the target site comprises a three-dimensional view of the target site, and wherein the augmented view of the target site comprises an augmented three-dimensional view of the target site, and wherein the user display device comprises a virtual reality headset.

10. A to provide a visual status of a location of interest, the method comprising:
transmitting at least one control command signal to an at least one unmanned aerial vehicle (UAV) commanding each of the at least one UAV to travel to a respective predetermined location defined by a predetermined set of coordinates;
receiving real-time video imagery of the target site from the camera of the at least one UAV;
establishing, via the transceiver of the at least one UAV, a communications link with one or more wireless connected devices in the target site, each of the wireless connected devices being coupled with a respective field sensor that monitors a status of an industrial component;
fetching, via the transceiver of the at least one UAV, parametric information collected from the respective field sensor, the parametric information being transmitted to the transceiver of the at least one UAV via the communications link;
preparing a view of the target site, the view of the target site being determined by assembling the real-time video imagery of the target site;
associating the parametric information collected from the respective field sensor with the corresponding industrial components found in the view of the target site; and,
preparing, for presentation to a user, an augmented view of the target site comprising the view of the target site overlaid with a visual representation of the parametric information collected from the respective field sensor.

11. The method of claim 10, wherein the operation of transmitting, via the control transceiver, at least one control command signal to an at least one UAV comprises commanding the at least one UAV to move in a predetermined motion profile.

12. The method of claim 11, wherein the predetermined motion profile comprises an orbit around the target site.

13. The method of claim 10, wherein the operation of transmitting, via the control transceiver, at least one control command signal to an at least one UAV comprises automatically dispatching the at least one UAV to the respective predetermined location defined by the predetermined set of coordinates, wherein the predetermined location is determined by a malfunction message originating from the target site.

14. The method of claim 10, wherein the at least one UAV comprises a plurality of UAVs, and wherein the operation of transmitting, via the control transceiver, at least one control command signal to an at least one UAV comprises commanding each of the plurality of UAVs to travel to different predetermined locations.

15. The method of claim 10, wherein the view of the target site comprises a three-dimensional view of the target site, and wherein the augmented view of the target site comprises an augmented three-dimensional view of the target site.

16. A method to provide a visual status of a location of interest, the method comprising:
transmitting at least one control command signal to an at least one unmanned aerial vehicle (UAV) commanding each of the at least one UAV to travel to a respective predetermined location defined by a predetermined set of coordinates;
step for receiving real-time video imagery of the target site;
establishing, via the transceiver of the at least one UAV, a communications link with one or more wireless connected devices in the target site, each of the wireless connected devices being coupled with a respective field sensor that monitors a status of an industrial component;
fetching, via the transceiver of the at least one UAV, parametric information collected from the respective field sensor, the parametric information being transmitted to the transceiver of the at least one UAV via the communications link;
preparing a view of the target site, the view of the target site being determined by assembling the real-time video imagery of the target site;
associating the parametric information collected from the respective field sensor with the corresponding industrial components found in the view of the target site; and,
preparing, for presentation to a user, an augmented view of the target site comprising the view of the target site overlaid with a visual representation of the parametric information collected from the respective field sensor.

17. The method of claim 16, wherein the operation of transmitting, via the control transceiver, at least one control command signal to an at least one UAV comprises commanding the at least one UAV to move in a predetermined motion profile.

18. The method of claim 17, wherein the predetermined motion profile comprises an orbit around the target site.

19. The method of claim 16, wherein the operation of transmitting, via the control transceiver, at least one control command signal to an at least one UAV comprises automatically dispatching the at least one UAV to the respective predetermined location defined by the predetermined set of coordinates, wherein the predetermined location is determined by a malfunction message originating from the target site.

20. The method of claim 19, wherein the at least one UAV comprises a plurality of UAVs, and wherein the operation of transmitting, via the control transceiver, at least one control command signal to an at least one UAV comprises commanding each of the plurality of UAVs to travel to different predetermined locations.
